(19) United States
(12) Patent Application Publication
(10) Pub. No.: US 2026/0329971 A1
(43) Pub. Date: Oct. 22, 2026

(54) FRAMEWORK FOR AGENT MONITORING AND MANAGEMENT

(71) Applicant: Salesforce, Inc., San Francisco, CA (US)

(72) Inventors: Nikhil KAPRE, Bengaluru (IN); Tarundeep BATRA, San Francisco, CA (US); Scott WHITE, Bellevue, WA (US); Sabir CHOWDHURY, Bengaluru (IN)

(21) Appl. No.: 19/180,440

(22) Filed: Apr. 16, 2025

(51) Int. Cl. G06F 18/21

(52) U.S. Cl. CPC G06F 18/217

(57) ABSTRACT

Systems, devices, and techniques are disclosed for a framework for agent monitoring and management. An output generated by a non-deterministic system may be received. Component metrics may be selected from natural language metrics and transactional metrics. The component metrics may be customizable. Metric scores may be generated for the output based on the selected component metrics. One of the generated metric scores may be determined to be lower than a threshold metric score for the component metric of the generated metric score. The generated metric scores may be compared to threshold metrics scores independently. The non-deterministic system may be disabled.

### BACKGROUND

Evaluating non-deterministic agents, such as agents that use large language models (LLMs), may be challenging due to the non-determinism. A non-deterministic agent may give different outputs for the same input, and the different outputs may both be correct, making it difficult to determine the appropriateness of the non-deterministic agents'outputs. Outputs from non-deterministic agents may also include natural language in addition to attributes from the input, further complicating the evaluation of non-deterministic agents'outputs. Traditional forms of evaluation for agents often include generating a single holistic metric for an agent, which may make it difficult to determine why an agent is performing poorly.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for a framework for agent monitoring and management according to an implementation of the disclosed subject matter.

FIG. 2 shows an example arrangement suitable for a framework for agent monitoring and management according to an implementation of the disclosed subject matter.

FIG. 3 shows an example arrangement suitable for a framework for agent monitoring and management according to an implementation of the disclosed subject matter.

FIG. 4 shows an example procedure suitable for a framework for agent monitoring and management according to an implementation of the disclosed subject matter.

FIG. 5 shows a computer according to an implementation of the disclosed subject matter.

FIG. 6 shows a network configuration according to an implementation of the disclosed subject matter.

### DETAILED DESCRIPTION

Techniques disclosed herein enable framework for agent monitoring and management, which may allow for the evaluation of outputs from non-deterministic agents for monitoring and management purposes. An input to and output generated by a non-deterministic system may be received. Component metrics may be selected from natural language metrics and transactional metrics. Metric scores may be generated for the output based on the selected component metrics. The component metrics may be customizable. A generated metric score may be determined to be lower than a threshold metric score for the component metric of the generated metric score. The generated metric scores may be compared to threshold metrics scores independently. The non-deterministic system may be disabled.

An input to and output generated by a non-deterministic system may be received. A non-deterministic system may be any system, including non-deterministic agents, that use a non-deterministic component such as large language model (LLM). The non-deterministic system may have received input such as, for example, a natural language request, and may have generated output in response to the input. The output may include any suitable combination of natural language text, attributes from the input, and other objects depending on the nature of the input. For example, a natural language request to track a specific order number may result in an output from a non-deterministic system of that order's status written in natural language and including the order number from the request along with other attributes about the order, such as the order date. A natural language request for appropriate hiking gear may result in an output from a non-deterministic system of a list of search results that are responsive to the request and may not include any natural language. Both the input to the non-deterministic system and the output generated by the non-deterministic system from that input may be received from any suitable source.

Component metrics may be selected from natural language metrics and transactional metrics. Transactional metrics and natural language metrics may be used to evaluate the output of non-deterministic systems. The transactional metrics and natural language metrics may each include any number of component metrics. Component metrics of the transactional metrics may include attribute accuracy, weighted attribute accuracy, list of matching attributes, and list of mismatched attributes. Attribute accuracy may be based on a count of the number of attributes in the output from the non-deterministic system that match attributes in an expected output of the non-deterministic system. Weighted attribute accuracy may attribute accuracy calculated with different weights given to the matching of different attributes. The list of matching attributes may be a list of output attributes that match with attributes in the expected output. The list of mismatched tributes may be a list of output attributes that did not match with attributes in the expected output. Component metrics of the natural language metrics may include text readability, best LLM output match, cohesiveness, conciseness, completeness, coherence, and intention match. Text readability may be a measure of how readable text in the output is. Best LLM output match may be a measure of how close the text of the output is to the best possible text an LLM could produce based on the input. Cohesiveness may be a measure of how logical the text structure of the output is in with regards to conveying a unified meaning. Conciseness may be a measure of the compactness of the text of the output. Completeness may be a measure of how complete the text of the output is as an answer to the input. Coherence may be a measure of how logically connected different parts of the text of the output are. Intention match may be a measure of how well the intent of the output text matches that intent of a natural language request in the input.

The selection of component metrics and the transactional metrics may be made based on the nature of the output received from the non-deterministic system. For example, if the output includes no natural language, for example, is a list of search results or a data object that includes attributes from the request without any generated text, only the transactional metrics may be selected. If the output does include natural language, for example, generated text, then natural language metrics may be selected. If the output includes both attributes from the request and natural language, both the transactional metrics and natural language metrics may be selected. The selection of component metrics may also be made based on a user-selected adapter for the output. The user-selected adapter may be a file, for example, a JSON file, which may define the evaluation to be performed on the output of the non-deterministic system, including specifying the component metrics to be used to score the output of the non-deterministic system. The user-selected adapted may, for example, be:

```
“accuracyTargets” : [
    {
      “name”: “merchant_create_promotion”,
      “cloud”: “COMMERCE”,
      “functionalDomain”: “MERCHANTS”,
      “functionalSubDomain”: “PROMOTIONS”,
      “accuracyTestName”: “CREATE_PROMOTION”,
      “coreTenantId”: “core/falcontest1-
      core4sdb3/00DSB00000D4Cvx”,
      “featureId”: “MerchantCopilot”,
      “llmDetails”: {
        “llm”: “GPT40”,
        “languageModel”:
        “llmgateway_{——}OpenAIGPT4Omni_05_13”,
        “llmApiKey”: “<<Enter your LLP API Key>>>>”,
        “llmApiUrl”: “https://bot-svc-
        llm.sfproxy.einstein.aws-dev4-
uswest2.aws.sf
        “apiHeaders”: {
          “Authorization”: “API_KEY <<Enter your own
          LLM API Key>>”,
          “Content-Type”: “application/json”,
          “x-client-feature-id”: “MerchantCopilot”,
          “x-sfdc-app-context”:“EinsteinGPT”,
          “x-sfdc-core-tenant-id”:“core/falcontest1-
core4sdb3/00DSB00000D4Cvx”
        }
    },
    “computationSteps”: [
      “ATTRIBUTE_ACCURACY”,
      “NATURAL_LANGUAGE_ACCURACY”,
      “NATURAL_LANGUAGE_READABILITY”,
      “NATURAL_LANGUAGE_INTENT_MATCH”
    ]
  }
]
```

Metrics scores may be generated for the output based on the selected component metrics of the selected one or both of the transactional metrics and the natural language metrics. The output may have a score determined for each of the component metrics from whichever of the natural language metrics and transactional metrics were selected. The scores for component metrics may be calculated in any suitable manner, for example, using any suitable component-metrics specific calculators. The component metrics may be customizable. Users may select their own calculators to be used for calculating component metrics. For example, a readability component metric may use, by default, a calculator that uses Automated Readability Index calculations. A user may elect to replace this default calculator with a calculator that uses Flesch-Kincaid Reading Ease calculations.

A generated metric score may be determined to be lower than a threshold metric score for the component metric of the generated metric score. The generated metric scores may be compared to threshold metrics scores independently. Every component metric may have a threshold metric score. The threshold metric score for a component metric may be set in any suitable manner and may be customizable by users for their own implementations. Each metric score for the output of the non-deterministic system generated for a component metric may be compared individually against the threshold metric score for that component metric to determine if the metric score is below the threshold metric score. Threshold metric scores may be set on a per-non-deterministic system basis. For example, two different non-deterministic systems may have different threshold metric scores for the same component metric using the same calculator. This may allow the threshold metric scores to be customized for different non-deterministic systems.

The non-deterministic system may be disabled. If the output of the non-deterministic system has a single metric score for a component metric that is below the threshold metric for that component metric, this may indicate a performance issue with the non-deterministic system. The non-deterministic system may be disabled until the performance issue can be corrected through any suitable remediating actions. Remediating actions to correct performance issues with a non-deterministic system may include, for example, determining any recent changes to code used by the non-deterministic system, including the code of any deterministic and non-deterministic components, and rolling back or undoing those changes. Appropriate parties may also be sent notifications so that they may attempt to correct any performance issues with the non-deterministic system.

Output from non-deterministic systems may have metric scores generated and compared to threshold metric scores at any suitable time and interval. For example, a non-deterministic system may have metric scores generated for its output and compared to threshold metric scores frequently enough that any drop off in performance of the non-deterministic system may be detected in real-, or almost real-, time. This may allow performance issues to be more readily traced to changes made to the non-deterministic system, as a performance issue caused by such a change may be detected soon after the change is made, rather than being detected later after several other changes have been made making it more difficult to determine which change is responsible for the performance issue.

The component metrics used to score the output of a non-deterministic system may be entirely user-selectable, user-customizable, and user-extensible. A user may select which component metrics should be used to test a non-deterministic system, may change the calculators used to calculate the metric scores for the component metrics, and may add new component metrics with user-selected calculators.

Feedback may be used to allow the non-deterministic system to become more accurate and reliable over time. The metric scores for the output of a non-deterministic system may be used to ground any non-deterministic components, such as LLMs, of the non-deterministic system. This may improve that non-deterministic component's understanding of user intent and context, minimizing errors, enhancing the relevance of output from the non-deterministic system.

In some implementations, output from deterministic systems may be evaluated in the same manner as output from non-deterministic systems and deterministic systems may be managed in the same manner as non-deterministic systems using the framework for agent monitoring and management.

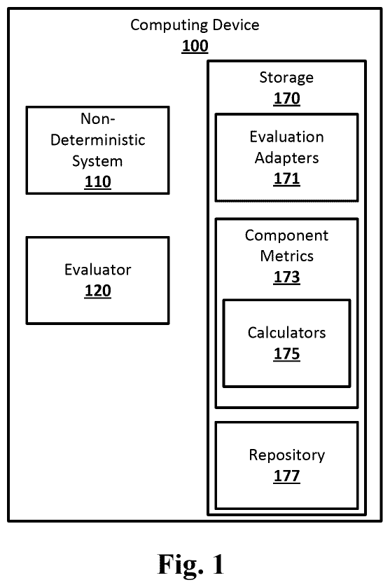

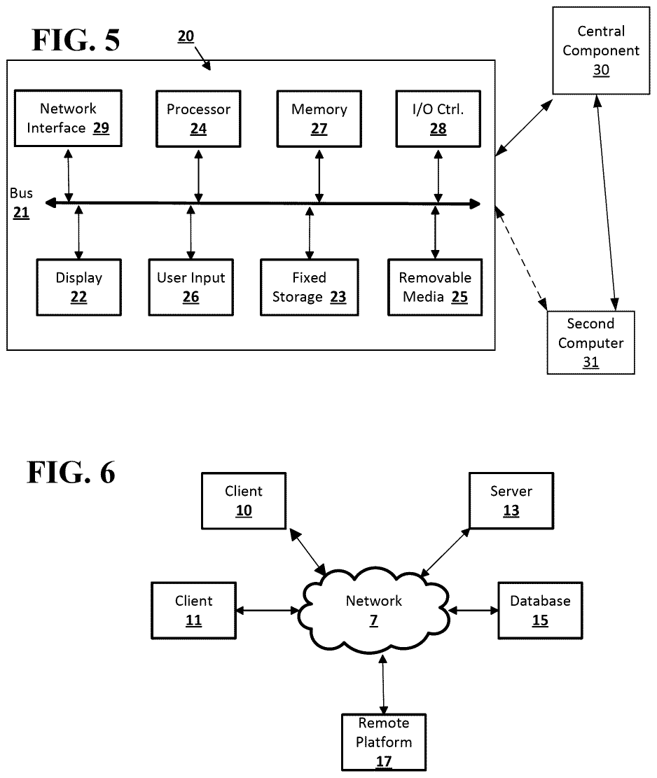

FIG. 1 shows an example system suitable for a framework for agent monitoring and management according to an implementation of the disclosed subject matter. A computing device 100 may be any suitable computing device, such as, for example, a computer 20 as described in FIG. 5, or component thereof, for implementing framework for agent monitoring and management. The computing device 100 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. The computing device 100 may be part of a computing system and network infrastructure, or may be otherwise connected to the computing system and network infrastructure, including a larger server network which may include other server systems similar to the computing device 100. The computing device 100 may include any suitable combination of central processing units (CPUs), graphical processing units (GPUs), and tensor processing units (TPUs). For example, the computing device 100 may be, or be part of, a cloud computing sever system that may be a multi-tenanted server system.

The computing device 100 may include a non-deterministic system 110. The non-deterministic system 110 may be any suitable combination of hardware and software of the computing device 100 for implementing a system that may be able to response to user queries using at least one component, such an LLM, that causes the output of non-deterministic system 110 to be non-deterministic. The non-deterministic system 110 may receive queries submitted by users and generate and return outputs that may respond to the queries. The use of an LLM or other non-deterministic component by the non-deterministic system 110 may result in the non-deterministic system 110 returning different outputs for the same input queries. The type of output generated by the non-deterministic system 110 may depend on the nature of the input request and may include any suitable combination of natural language text, lists such as search results, and data objects that include attributes directly from or derived from the input request. For example, an input request that includes request to generate a promotion along with parameters for that promotion may result in the non-deterministic system 110 generating an output that is a data object that can be used to implement a promotion on a suitable system and includes the parameters from the input request. An input request that includes a request for a summary of an order status may result in the non-deterministic system 110 generating an output that includes natural language text describing the status of the order along with data attributes directly from the input request, such as the order number, and data attributes determined from that input request such as dates and locations associated with the progress of the order.

The computing device 100 may include an evaluator 120. The evaluator 120 may be any suitable combination of hardware and software of the computing device 100 for implementing an evaluator system for scoring the output of the non-deterministic system 110. The evaluator 120 may, for example, receive output from the non-deterministic system 110 and the input request that resulted in the output, determine component metrics from component metrics 173 to be used to score the output, determine calculators from the calculators 175 to be used with the determined component metrics, score the output of the non-deterministic system 110 using the determined calculators for the determined component metrics to generate metric scores for the output, compare the metric scores for the output to threshold metric scores for that metric score's component metric, and take remediating actions when a metric score for the output is below the threshold metric score for that metric score's component metric. Remediating actions taken by the evaluator 120 may include, for example, disabling the non-deterministic system 110, rolling back code changes to code in a repository 177 for components used by the non-deterministic system 110, and grounding an LLM used by the non-deterministic system 110. The evaluator 120 may determine which component metrics of the component metrics 173 to use to score the output of the non-deterministic system 110 in any suitable manner. For example, the evaluator 120 may determine component metrics based on the nature of the output of the non-deterministic system 110. If the output includes generated text in natural language, the evaluator 120 may use natural language metrics. If the output includes transactional data, the evaluator 120 may use transactional metrics. The evaluator 120 may also determine which component metrics from the component metrics 173 to use to score the output of the non-deterministic system 110 based on a user-selected adapter from the adapters 171. The user-selected adapter may be written by a user specifically for the non-deterministic system 110 and may specify which components metrics to use to score the output of the non-deterministic system 110 along with which calculators should be used within the specified component metrics. A single non-deterministic system, such as the non-deterministic system 110, may have any number of user-selected adapters, and different non-deterministic systems may have their own, different, user-selected adapters. The use of user-selected adapters with user-selected component metrics and user-specified calculators may allow for a flexible framework for monitoring and managing intelligent agents, such as non-deterministic systems that incorporate machine learning system components such as LLMs.

The storage 170 may be any suitable combination of hardware and software for storing data. The storage 170 may include any suitable combination of volatile and non-volatile storage hardware and may include components of the computing device 100 and hardware accessible to the computing device 100, for example, through wired and wireless direct or network connections. The storage 170 may store the adapters 171, the component metrics 173, the calculators 175, and the repository 177. The adapters 171 may store any suitable user-selected adapters which may be stored in any suitable format, including, for example, as JSON files. The component metrics 173 may store any suitable component metrics, including natural language metrics and transactional metrics, that may be received from any suitable source, including, for example, from users who may add additional component metrics. The calculators 175 may store any suitable calculators for calculating component metrics, including, for example, calculators supplied by users, and may store multiple calculators for the same component metric. For example, a component metric of readability may have multiple different readability calculators stored in the calculators 175. The repository 177 may be a code repository that may store code used by non-deterministic systems, such as the non-deterministic system 110. The repository 177 may including versioning and change data that may allow the evaluator 120 to determine and roll back changes made to code in the repository 177 when, for example, output from a non-deterministic system such as the non-deterministic system 110 receives metric scores for component metrics that are below the threshold metric scores for those component metrics.

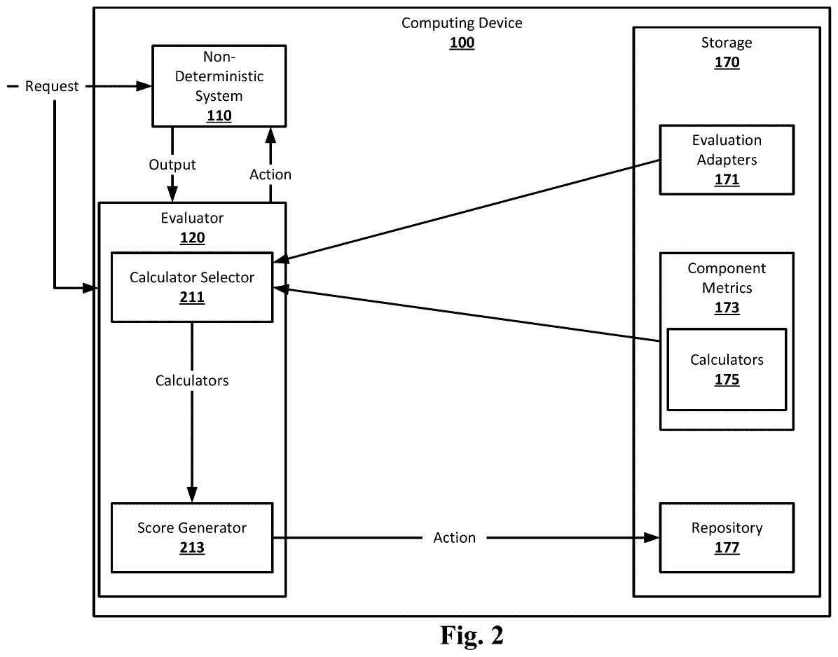

FIG. 2 shows an example arrangement suitable for a framework for agent monitoring and management according to an implementation of the disclosed subject matter. A request may be received as input at the non-deterministic system 110. The request may be, for example, a natural language request received from a user for which the user wants the non-deterministic system 110 to generate a response. The non-deterministic system 110 may generate output in response to the request using any suitable components, including non-deterministic components such as an LLM. The nature of the output generated by the non-deterministic system 110 may be based on the nature of the request, may be in any suitable format, and may include any suitable combination of generated natural language text, attributes from the request, attributes derived from the request, search results, and other data. The output may, for example, be entirely natural language text, natural language text mixed with attributes, or may be, for example, a data object for use with any other application. The output may be provided to the user who input the request to the non-deterministic system 110.

The evaluator 120 may receive the request input to the non-deterministic system 110 and the output generated by the non-deterministic system 110 in response to receiving the request. A calculator selector 211of the evaluator 120 may select the appropriate calculators to use to generate metric scores for the output of the non-deterministic system 110. The calculator selector 211 may, for example, determine an appropriate adapter, such as user-selected adapter, for the non-deterministic system 110 from the evaluation adapters 171. The adapter may specify which component metrics of the component metrics 173 should be used to generate metric scores for the output of the non-deterministic system 110 and may further which of the calculators 175 should be used for each of the specified component metrics if the default calculator for a component metric is not used. The calculator selector 211 may then select the calculators from the calculators 175 specified for component metrics in the adapter, or the default calculators if no calculator is specified for a specified component metric.

A score generator 213 of the evaluator 120 may generate metric scores across the component metrics for the output of the non-deterministic system 110 based on the calculators selected by the calculator selector 211. The score generator 213 may use the selected calculators from the calculators 175 on the output of the non-deterministic system 110 and on the request that was input to the non-deterministic system 110 to generate a metric score for each component metric specified in the adapter for the non-deterministic system 110 from the evaluation adapters 171. The metric scores may be generated separately for each component metric. The calculators selected from the calculators 175 may operate in any suitable manner and may use any suitable components or systems to generate the metric scores. For example, calculators may make use of other LLMs, for example, LLMs different from those used by the non-deterministic system 110, to generate metric scores for the output of the non-deterministic system 110. Calculators may use LLMs when, for example, evaluating natural language text in the output against the best possible natural language text that an LLM can generate based on the same request.

The evaluator 120 may compare the metric scores generated by the score generator 213 for the component metrics to threshold metric scores for those component metrics. If any metric score is determined to be below the threshold metric scores for its component metric the evaluator 120 may take, or initiate the taking of, remediating action. For example, the evaluator 120 may disable the non-deterministic system 110. The evaluator 120 may also roll back or undo recent updates to code used by the non-deterministic system 110 in the repository 177, as these updates may be responsible for a deterioration in the performance of the non-deterministic system 110. The evaluator 120 may also improve the accuracy of the non-deterministic system 110, for example, using a feedback loop to improve the grounding of any LLMs or other non-deterministic components used by the non-deterministic system 110.

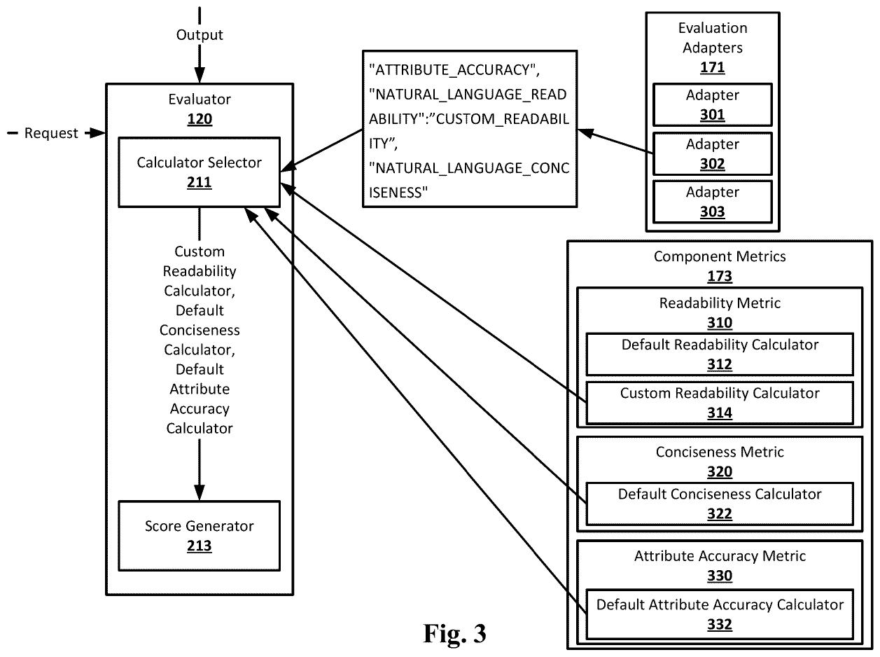

FIG. 3 shows an example arrangement suitable for a framework for agent monitoring and management according to an implementation of the disclosed subject matter. Upon receiving output generated by the non-deterministic system 110 and the request that was input to the non-deterministic system 110 that resulted in the generation of the output, the evaluator 120 may determine which component metrics and calculators to use to generate metric scores for the non-deterministic system 110. The calculator selector 211 may check the evaluation adapters 171 to determine if there is an adapter that indicates which component metrics and calculators should be used to generate metric scores for the output of the non-deterministic system 110. For example, from among an adapter 301, and adapter 302, and an adapter 303, the adapter 302 may include an indication that it should be used to generate metric scores for the output of the non-deterministic system 110. The calculator selector 211 may read the adapter 302, which may be, for example, a JSON, file, and may determine that the evaluator 120 should generate metric scores for the output of the non-deterministic system 110 for each of an attribute accuracy component metric, a natural language readability component metric, and a natural language conciseness component metric. The calculator selector 211 may further determine that the adapter 302 specifies a custom readability calculator is specified for the natural language readability component metric but does not specify calculators for the attribute accuracy component metric or the natural language conciseness component metric. The calculator selector 211 may select from the component metric 173 for readability metric 310, a custom readability calculator 314 instead of a default readability calculator 312. For a conciseness metric 320, the calculator selector 211 may select a default conciseness calculator 322, and for an attribute accuracy metric 330, the calculator selector 211 may select a default attribute accuracy calculator 332. The custom readability calculator 314, default conciseness calculator 322, and default attribute accuracy calculator 332 may be sent to the score generator 213 which may use them to calculator separate metric scores for the output of the non-deterministic system 110 across the component metrics of readability, conciseness, and attribute accuracy. The use of adapters, such as the adapter 302, and allowance of custom calculators, such as the custom readability calculator 314, to be used to score the output of a non-deterministic system may allow for a flexible framework for monitoring and managing the non-deterministic systems. Different non-deterministic systems may be subjected to different scoring across different component metrics and different calculators for the component metrics to determine if the non-deterministic systems are functioning with acceptable levels of accuracy and readability.

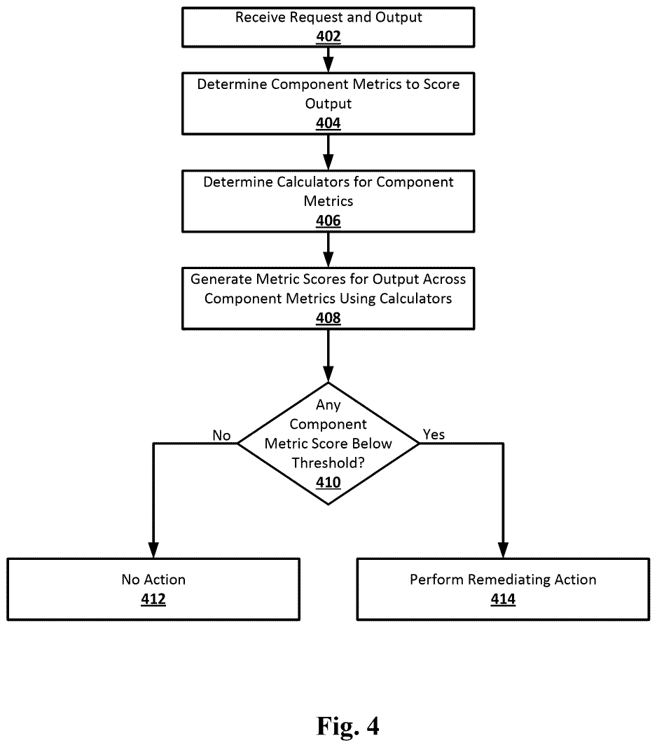

FIG. 4 shows an example procedure suitable for a framework for agent monitoring and management according to an implementation of the disclosed subject matter. At 402, a request and output may be received. For example, the evaluator 120 may receive a request that was input to the non-deterministic system 110 and the output that the non-deterministic system 110 in response to the request. The request may be, for example, a natural language request from a user. The output may be in any suitable format, including, for example, text or a data object, and may include any suitable contents, for example, generated natural language text, attributes from the request, and data derived from attributes from the request.

At 404, component metrics to score the output for may be determined. For example, the evaluator 120 may determine which component metrics of the component metrics 173 for which the evaluator 120 should generate metric scores for the output of the non-deterministic system 110. The evaluator 120 may determine the component metrics in any suitable manner. For example, the evaluator 120 may determine the component metrics based on the content and format of the output, selecting natural language component metrics for output that includes natural language, transactional component metrics for output that includes attributes from the request and data derived therefrom, and both for output that includes both. The evaluator 120 may also determine if the evaluation adapters 171 include a user-selected adapter for evaluating output from the non-deterministic system 110. The user-selected adapter may specify the component metrics of the component metrics 173 for which metrics scores should be generated for the output of the non-deterministic system 110.

At 406, calculators for the component metrics may be determined. The component metrics, of the component metrics 173, for which the evaluator 120 may generate metrics scores for the output of the non-deterministic system 110 may have any number of associated calculators used to generate the metrics scores. For example, the readability metric 310 may be associated with the default readability calculator 312 and the custom readability calculator 314, either of which may be used to generate a readability metric score for the output of the non-deterministic system 110. The evaluator 120 may determine which calculator to use for each component metric for which the evaluator 120 may generate metrics scores for the output of the non-deterministic system 110 in any suitable manner. For example, if the evaluator 120 determined the component metrics from a user-selected adapter, the user-selected adapter may also specify the calculators for the component metrics. Otherwise, if there is no user-selected adapter, or the user-selected adapter does not specify a calculator, the evaluator 120 may use default calculators for the component metric.

At 408, metrics scores may be generated for the output across the component metrics using the calculators. For example, the evaluator 120 may use the determined calculators, such as the custom readability calculator 314, default conciseness calculator 322, and attribute accuracy calculator 332, to generate a score for the output of the non-deterministic system 110 across the respective determined component metrics. This may result in the evaluator 120 generating a single, separate, metric score for each component metric, with each score generated using the selected calculator for that component metric. For example, a metric score for the readability metric 310 may be generated using the custom readability calculator 314, a metric score for the conciseness metric 320 may be generated using the default conciseness calculator 322, and a metric score for the attribute accuracy metric 330 may be generated using the attribute accuracy calculator 332.

At 410, if any metric score for a component metric is below the threshold metric score for the component metric, 412. Otherwise, flow may proceed to 414. For example, the metric scores for the component metrics used to score the output of the non-deterministic system 110 may be compared to threshold metric scores for their respective component metrics. Any metric score for a component metric being below the threshold metric score for that component metric may indicate performance issues with the non-deterministic system 110. Otherwise, if all metric scores are at or above the threshold metric scores for their component metrics, there may be no performance issues with the non-deterministic system 110.

At 412, no action may be taken. For example, the metric scores for the component metrics for the output of the non-deterministic system 110 may have been determined to not be below the threshold metric scores for the component metrics. This may indicate that the non-deterministic system 110 is functioning properly and no remediating actions need to be taken.

At 414, a remediating action may be performed. For example, any of the metric scores for the component metrics for the output of the non-deterministic system 110 may have been determined to be below the threshold metric score for its component metric. This may indicate that the non-deterministic system 110 is not functioning properly and may be returning lower-quality or less accurate output. The evaluator 120, or any other suitable component of the computing device 100, may perform any suitable remediating actions on the non-deterministic system 110. For example, the non-deterministic system 110 may be temporarily disabled to prevent users from receiving lower-quality or less accurate output. The non-deterministic system 110 may be reverted to a state of the non-deterministic system that existed prior to a recent change to the non-deterministic system 110, for example, by rolling back code used by the non-deterministic system 110 in the repository 177 to undo any recent updates or changes to the code that may have degraded the performance of the non-deterministic system 110. The performance of the non-deterministic system 110 may also be improved, for example, by further grounding any LLMs used by the non-deterministic system 110, updating weights used by the LLMs.

Implementations of the presently disclosed subject matter may be implemented in and used with a variety of component and network architectures. FIG. 5 is an example computer 20 suitable for implementing implementations of the presently disclosed subject matter. As discussed in further detail herein, the computer 20 may be a single computer in a network of multiple computers. As shown in FIG. 5, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 6.

Many other devices or components (not shown) may be connected in a similar manner (e.g., document scanners, digital cameras and so on). Conversely, all of the components shown in FIG. 5 need not be present to practice the present disclosure. The components can be interconnected in different ways from that shown. The operation of a computer such as that shown in FIG. 5 is readily known in the art and is not discussed in detail in this application. Code to implement the present disclosure can be stored in computer-readable storage media such as one or more of the memory 27, fixed storage 23, removable media 25, or on a remote storage location.

FIG. 6 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
receiving an output generated by a non-deterministic system;
selecting component metrics from natural language metrics and transactional metrics, wherein the component metrics are customizable;
generating metric scores for the output based on the selected component metrics;
determining that at least one of the generated metric scores is lower than a threshold metric score for the component metric of the at least one of the generated metric scores, wherein the generated metric scores are compared to threshold metrics scores independently; and
disabling the non-deterministic system.

2. The computer-implemented method of claim 1, wherein selecting component metrics from natural language metrics and transactional metrics comprises selecting component metrics based on properties of the output.

3. The computer-implemented method of claim 1, wherein selecting component metrics from natural language metrics and transactional metrics comprises selecting component metrics specified in an adapter for the non-deterministic system.

4. The computer-implemented method of claim 1, wherein selecting component metrics from natural language metrics and transactional metrics further comprises selecting calculators for the component metrics, and wherein generating metric scores for the output based on the selected component metrics further comprises using the selected calculators to generate the metric scores.

5. The computer-implemented method of claim 1, wherein calculators for the component metrics are customizable.

6. The computer-implemented method of claim 1, further comprising, after disabling the non-deterministic system:
determining at least one change to the non-deterministic system made before the disabling of the non-deterministic system;
reverting the non-deterministic system to a state of the non-deterministic system that existed prior to the determined at least one change; and
enabling the non-deterministic system.

7. The computer-implemented method of claim 6, wherein the at least one change comprises a change to code of the non-deterministic system or a change to weights of a large language model used by the non-deterministic system.

8. A computer-implemented system comprising:
one or more storage devices; and
a processor that receives an output generated by a non-deterministic system,
selects component metrics from natural language metrics and transactional metrics, wherein the component metrics are customizable,
generates metric scores for the output based on the selected component metrics,
determines that at least one of the generated metric scores is lower than a threshold metric score for the component metric of the at least one of the generated metric scores, wherein the generated metric scores are compared to threshold metrics scores independently, and
disables the non-deterministic system.

9. The computer-implemented system of claim 8, wherein the processor selects component metrics from natural language metrics and transactional metrics by selecting component metrics based on properties of the output.

10. The computer-implemented system of claim 8, wherein the processor selects component metrics from natural language metrics and transactional metrics by selecting component metrics specified in an adapter for the non-deterministic system.

11. The computer-implemented system of claim 8, wherein the processor selects component metrics from natural language metrics and transactional metrics by selecting calculators for the component metrics, and wherein the processor generates metric scores for the output based on the selected component metrics by using the selected calculators to generate the metric scores.

12. The computer-implemented system of claim 8, wherein calculators for the component metrics are customizable.

13. The computer-implemented system of claim 8, wherein the processor, after disabling the non-deterministic system:
determines at least one change to the non-deterministic system made before the disabling of the non-deterministic system,
reverts the non-deterministic system to a state of the non-deterministic system that existed prior to the determined at least one change, and
enables the non-deterministic system.

14. The computer-implemented system of claim 13, wherein the at least one change comprises a change to code of the non-deterministic system or a change to weights of a large language model used by the non-deterministic system.

15. A system comprising: one or more computers and one or more non-transitory storage devices storing instructions which are operable, when executed by the one or more computers, to cause the one or more computers to perform operations comprising:
receiving an output generated by a non-deterministic system;
selecting component metrics from natural language metrics and transactional metrics, wherein the component metrics are customizable;
generating metric scores for the output based on the selected component metrics;
determining that at least one of the generated metric scores is lower than a threshold metric score for the component metric of the at least one of the generated metric scores, wherein the generated metric scores are compared to threshold metrics scores independently; and
disabling the non-deterministic system.

16. The system of claim 15, wherein the instructions which are operable, when executed by the one or more computers, to cause the one or more computers to perform operations comprising selecting component metrics from natural language metrics and transactional metrics further cause the one or more computers to perform operations comprising selecting component metrics based on properties of the output.

17. The system of claim 15, wherein the instructions which are operable, when executed by the one or more computers, to cause the one or more computers to perform operations comprising selecting component metrics from natural language metrics and transactional metrics further cause the one or more computers to perform operations comprising selecting component metrics specified in an adapter for the non-deterministic system.

18. The system of claim 15, wherein the instructions which are operable, when executed by the one or more computers, to cause the one or more computers to perform operations comprising selecting component metrics from natural language metrics and transactional metrics further cause the one or more computers to perform operations comprising selecting calculators for the component metrics, and wherein the instructions which are operable, when executed by the one or more computers, to cause the one or more computers to perform operations comprising generating metric scores for the output based on the selected component metrics further cause the one or more computers to perform operations comprising using the selected calculators to generate the metric scores.

19. The system of claim 15, wherein calculators for the component metrics are customizable.

20. The system of claim 15, wherein the instructions are operable, when executed by the one or more computers, to further cause the one or more computers to perform operations comprising, after disabling the non-deterministic system:
determining at least one change to the non-deterministic system made before the disabling of the non-deterministic system;
reverting the non-deterministic system to a state of the non-deterministic system that existed prior to the determined at least one change; and
enabling the non-deterministic system.
